(19) United States
(12) Patent Application Publication
(10) Pub. No.: US 2019/0376413 A1
(43) Pub. Date: Dec. 12, 2019

(54) Burst Protection Device For A Turbo Machine

(71) Applicant: MAN Energy Solutions SE, Augsburg (DE)

(72) Inventors: Urban SPATZ, Neusaess (DE); Steffen BRAUN, Augsburg (DE); Daniel ALBRECHT, Augsburg (DE); Harald DENKEL, Baar (DE); Stefan WEIHARD, Augsburg (DE); Bernd HAAS, Neusaess (DE); Johannes NIEBUHR, Augsburg (DE)

(21) Appl. No.: 16/428,414

(22) Filed: May 31, 2019

(30) Foreign Application Priority Data
Jun. 6, 2018 (DE) DE102018113396.0

(51) Int. Cl. F01D 21/04

(52) U.S. Cl. CPC F01D 21/045; F05D 2220/40

(57) ABSTRACT

A burst protection device for a turbo machine having a rotor housing, which includes an axle and a rotor that is rotatably mounted about the axle in the rotor housing. The burst protection device surrounds the rotor housing at least in the region of the rotor in a circumferential direction of the rotor and is formed in one part of at least one burst protection element. The at least one burst protection element is a material having an elongation at break of at least 30%.

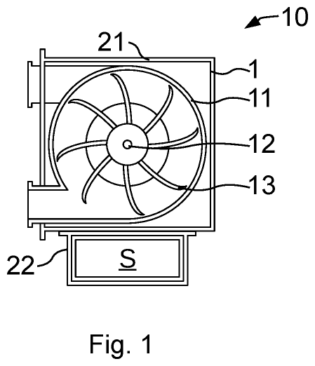

### BACKGROUND OF THE INVENTION

### 1. Field of the Invention

The invention relates to a burst protection device for a turbo machine, preferentially a turbine or a compressor.

### 2. Description of the Related Art

In the prior art, different burst protection devices for turbo machines are known. Burst protection devices serve for intercepting parts that fly about in the event of a bursting of parts of turbo machines, such as for example during the bursting of an impeller or rotor of a turbo machine so that these parts do not pose any danger to persons and adjacent machines are not damaged. However, burst protection devices known in the prior art are mostly expensive to manufacture because of their construction and their material and are very heavy.

### SUMMARY OF THE INVENTION

One aspect of the invention is therefore based on providing a favorable and light-weight burst protection device for turbo machines, which at the same time offers a high degree of protection against parts flying about in the case of a bursting.

According to one aspect of the invention, a burst protection device for a turbo machine with a rotor housing is proposed. The rotor housing comprises an axle and a rotor that is rotatably mounted about the axle in the rotor housing. The burst protection device encloses the rotor housing at least in the region of the rotor in a circumferential direction of the rotor. Furthermore, the burst protection device is formed as one part and preferentially in one piece consisting of at least one burst protection element. The at least one burst protection element consists of a material having an elongation at break of at least 30%.

During the bursting of rotating components such as for example during the bursting of the rotor, the parts created by the bursting often strike through the rotor housing. Sometimes, the rotor housing is virtually blown to pieces so that the parts of the rotor housing are added to the original parts of the rotor. By a burst protection device having a burst protection element consisting of a material with an elongation at break of at least 30%, the kinetic energy of the parts flying about is completely converted into deformation energy of the burst protection element when the parts flying about strike the burst protection element, wherein the burst protection element by way of its material has a sufficiently high notch impact strength so as to be deformed by the flying parts but not fractured and preferentially completely withstands the flying parts. Because of this, the flying parts are decelerated and intercepted by the burst protection element. Furthermore, a high notch impact strength is advantageous since by such a material with an elongation at break above 30%, more kinetic energy of flying parts is converted into deformation energy of the burst protection element than is the case with protective devices with “standard materials” known in the prior art. With “standard materials”, the flying parts would strike through the burst protection element and, although decelerated, however would not be stopped, as a result of which a part of the kinetic energy of the parts is not converted by the burst protection element. Because of the high elongation at break and the high notch impact strength, the burst protection device can be formed from a comparatively thin material and few layers stacked on top of one another, so that weight can be saved and the manufacturing method of the burst protection device is more cost-effective. The material is preferentially a stainless steel.

Because of the low weight and the few layers, the burst protection device has a low susceptibility to vibrations so that the susceptibility to vibrations of the entire turbo machine is reduced as well. Because of the low weight and the saving in volume accompanied by the construction, a small dimensioning of the burst protection device and of the turbo machine is possible and a connection to surrounding assemblies or components simplified. In addition, the assembly of the burst protection device or of the turbo machine is simplified.

In an advantageous further development of the burst protection device, the burst protection element encloses the rotor housing in the region of the rotor at least in part in the circumferential direction of the rotor, wherein the burst protection element, furthermore, extends along the rotor in the direction of the axle. The burst protection element in this case preferentially encloses the rotor housing completely.

A further advantageous configuration of the invention provides that the burst protection element is formed from at least one plate. Accordingly, the burst protection element can be formed in one part of multiple plates.

A version of the invention in which the burst protection element is formed in one piece from exactly one plate or the burst protection device is formed in one piece from exactly one burst protection element of exactly one plate is particularly advantageous.

Alternatively, the burst protection device can be provided of multiple burst protection elements and preferentially in one part.

In general, in one piece means that the burst protection device or the burst protection element is produced from one piece, i.e. for example from a single plate. A burst protection device or a one-part burst protection element formed in one part can be in one piece but can also be formed of multiple individual elements and joined into one part for example by screwing, riveting, or welding.

When the burst protection element in a further advantageous embodiment is formed of multiple plates, it has a construction by layers which is defined by at least two plates layered on top of one another.

In order to increase the stability of the burst protection device, a further configuration version provides that the plates are connected to one another in a firmly bonded or positively joined manner. For example, the plates can be welded to one another. In a positively joined connection, the plates can each form a frame or a part of a frame about the rotor housing, wherein in each case a frame located inside fits into a frame located outside and lies against the same so that the frames cannot move relative to one another. The frame located outside can also be bent about the frame located inside, so that the frames are only positively joined by the bending operation or the manufacturing method of the outer frame.

Advantageously, it is provided in a further embodiment that the plate has a thickness between 1 mm and 10 mm, preferentially between 5 mm, and 10 mm and further preferentially approximately 5 mm. By a thickness of the plate between 1 mm and 10 mm or equal to 5 mm, the burst protection element can be formed of exactly one plate, which is deformable by a bending method without the plate being damaged by the bending method. In particular with thicknesses from 5 mm, the burst protection device is significantly less susceptible to vibrations.

Accordingly, a design version of the burst protection device provides that the burst protection element is formed by transforming the plate by bending.

In an advantageous further development, the material of the burst protection device or of the plate is a solution-annealed austenitic corrosion-resistant steel preferentially providing the elongation at break of at least 30%.

Furthermore, the material in an advantageous embodiment comprises 00.02 to 00.12% carbon, 00.50 to 01.50% silicon, 01.50 to 02.50% manganese, 00.00 to 00.10% phosphorus, 00.00 to 00.10% sulphur, 15.00 to 25.00% chromium, 00.00 to 01.00% nitrogen, and 05.00 to 15.00% nickel.

Preferentially, the material comprises 00.07% carbon, 01.00% silicon, 02.00% manganese, 00.00 to 00.045% phosphorus, 00.00 to 00.015% sulphur, 17.50 to 19.50% chromium, 00.00 to 00.10% nitrogen, and 08.00 to 10.50% nickel.

According to one aspect of the invention, a turbo machine with a turbo machine housing and a rotor housing is proposed, furthermore. The turbo machine housing surrounds the rotor housing and is formed in one part of a first housing section and a second housing section. The first housing section is formed by the burst protection device. A material of the first and second housing section differs so that for example the first housing section can be formed from a heavier material with a higher elongation at break than the second housing section. Because of this, the turbo machine housing can be formed suitable for burst protection, so that regions, in which bursting can be expected, can be designed with a burst protection device matched thereto and the further regions, which are surrounded by the second housing section, can be formed of a lighter less stable material.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Other advantageous further developments of the invention are marked in the subclaims or are shown in more detail in the following together with the description of the preferred embodiment of the invention by way of the figure.

The FIGURE shows an exemplary schematic construction of a turbo machine with a burst protection device.

### DETAILED DESCRIPTION OF THE PRESENTLY PREFERRED EMBODIMENTS

The turbo machine 10 shown in the FIGURE is a turbocharger. In a rotor housing 11, a rotor 11, driven by hot exhaust gases, rotates about the axle 12. In order to minimize the risk for surrounding equipment and persons during a bursting rotor 11, a burst protection device according to one aspect of the invention is arranged about the rotor housing 11. The burst protection device is formed by a burst protection element 1, which surrounds the rotor 13 in its circumferential direction about the axle 12 and in the process also encloses the rotor housing 11 in its interior. In a longitudinal direction of the axle 12 lying orthogonally to the plane of presentation, the burst protection element 1 extends over the entire width of the rotor 13 in the longitudinal direction of the axle 12.

When for example a burst of a blade of the rotor 13 occurs, at least one part of the blade is flung against the rotor housing 11, which is mostly embodied as a casting. Because of the impact, the rotor housing 11, the part of the blade and under certain conditions further blades of the rotor 13 are blown to pieces or destroyed as a result of which multiple parts, in the following referred to as projectiles, are flung with a high velocity from the axle 12 in the radial direction to the outside. The projectiles (flying parts) can also strike through the remaining rotor housing 11 or cause the same to burst completely. When the projectiles strike the burst protection device formed of the burst protection element 1, the burst protection element 1 is deformed wherein, because of its high notch impact strength and its elongation at break of over 30% does not break or tear. By way of the deformation, the kinetic energy of the projectiles is converted into a deformation energy acting on the burst protection element 1 until no kinetic energy of the projectiles is present any longer. The projectiles can also bounce off the burst protection element 1 and, through multiple impacts on the burst protection element 1, lose their kinetic energy and the kinetic energy expended in the interior of the burst protection element.

The turbo machine 10 shown in the FIGURE additionally comprises a sensor system S for detecting various characteristic values such as for example a rotational speed of the rotor 13. The entire turbo machine is surrounded by a common turbo machine housing, wherein the rotor housing 11, the rotor 13 is provided in a first housing section 21 and the sensor system S in a second housing section 22. The first housing section 21 is formed by a burst protection device with a burst protection element 1, wherein the second housing section 22 is attached to the same for example by screws. In order to realize a cost-effective turbo machine housing, the first housing section 21 is produced from a material according to the specifications of the burst protection device with a high notch impact strength and an elongation at break of at least 30%, whereas the second housing section 22 can be produced for example from plastic. Instead of a sensor system S or in addition to the same, further components of the turbo machine 10 can also be arranged in the second housing section 22.

In its embodiment, the invention is not restricted to the preferred exemplary embodiments stated above. On the contrary, a number of versions is conceivable which makes use of the shown solution even with embodiments of a fundamentally different type.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A burst protection device for a turbo machine having a rotor housing, which includes an axle and a rotor that is rotatably mounted about the axle in the rotor housing, comprising:
at least one burst protection element that is formed in one part and configured to enclose the rotor housing in a circumferential direction at least in a region of the rotor, wherein the at least one burst protection element is a material having an elongation at break of at least 30%.

2. The burst protection device according to claim 1,
wherein in the region of the rotor the burst protection element encloses the rotor housing at least in part in the circumferential direction of the rotor and extends along the rotor in a direction of the axle.

3. The burst protection device according to claim 1, wherein the burst protection element is formed of at least one plate.

4. The burst protection device according to claim 3, wherein one of:
the burst protection element is formed in one piece of exactly one plate and
the burst protection device is formed in one piece of exactly one plate.

5. The burst protection device according to claim 3, wherein the burst protection element has a layered structure, comprising at least two plates layered on top of one another.

6. The burst protection device according to claim 5, wherein the at least two plates are connected to one another in a firmly bonded or positively joined manner.

7. The burst protection device according to claim 3, wherein the plate has a thickness between 1 mm and 10 mm.

8. The burst protection device according to claim 3, wherein the burst protection element is formed by bending of the plate.

9. The burst protection device according to claim 1, wherein the material is a solution-annealed austenitic corrosion-resistant steel.

10. The burst protection device according to claim 1, wherein the material comprises:
00. 02 to 00.12% carbon,
00.50 to 01.50% silicon,
01.50 to 02.50% manganese,
00.00 to 00.10% phosphorus,
00.00 to 00.10% sulphur,
15.00 to 25.00% chromium,
00. 00 to 01.00% nitrogen, and
05. 00 to 15.00% nickel.

11. A turbo machine comprising:
a rotor housing;
a turbo machine housing that surrounds the rotor housing and is produced in one part of a first housing section and a second housing section,
wherein the first housing section of a burst protection device is formed in one part and configured to enclose the rotor housing in a circumferential direction at least in a region of a rotor, wherein the at least one burst protection element is a material having an elongation at break of at least 30%, and
wherein the material of the first and second housing sections is dissimilar.

12. The burst protection device according to claim 7, wherein the plate has a thickness of 5 mm.
